(19) United States
(12) Patent Application Publication
(10) Pub. No.: US 2008/0018249 A1
(43) Pub. Date: Jan. 24, 2008

(54) PLASMA DISPLAY PANEL AND PRODUCTION PROCESS OF SAME

(76) Inventors: Tatsutoshi Kanae, Miyazaki (JP); Hiroshi Yamanaka, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/781,991

(22) Filed: Jul. 24, 2007

(30) Foreign Application Priority Data
Jul. 24, 2006 (JP) 2006-200392

(51) Int. Cl. H01J 17/49; H01J 1/62; H01J 9/00

(52) U.S. Cl. 313/586; 445/24

(57) ABSTRACT

To extend phosphor lifetime and lower the production cost of forming the phosphors.

A plurality of display electrodes 11, a dielectric layer 14 which covers the display electrodes 11, and a protective layer 15 which covers the dielectric layer 14 are formed on a front side first substrate 10, a plurality of address electrodes ADD, which intersect the display electrodes and form unit emission regions at the intersections, are formed on the second substrate 20, and a third electrode 30 is adhered on the second substrate with phosphors 36 interposed therebetween; and the first and the second substrates are sealed with a barrier 24 which demarcates the unit emission regions interposed therebetween. Since the phosphors 36 are separated from a discharge space by the second substrate 20, deterioration thereof caused by ion bombardment is prevented.

### BACKGROUND OF THE INVENTION

The present invention relates to a plasma display panel and a production process thereof, and more particularly, to a novel structure of a plasma display panel, which improves the lifetime of phosphors and eliminates deterioration of characteristics, and a production process thereof.

Plasma display panels have become popular in recent years. These plasma display panels employ a three-electrode surface discharge structure. Display electrodes extending in the horizontal direction, a dielectric layer covering the display electrodes, and a protective layer protecting the dielectric layer, are formed on a front substrate, while address electrodes intersecting with the display electrodes, a striped or matrix-like barrier, which demarcates unit emission regions where the display electrodes and the address electrodes intersect, and phosphors, provided on the address electrodes and side walls of the barrier, are formed on a back substrate.

In this type of three-electrode surface discharge type of plasma display panel, an address discharge is generated between the display electrodes and the address electrodes, a wall charge accumulates on the dielectric layer, and a sustain discharge is repeated between the display electrode pairs to emit light of a desired brightness. Since the sustain discharge, which accounts for the majority of the discharge, occurs between the display electrode pairs, the phosphors are not subjected to ion bombardment during discharge, thereby enabling the lifetime of the phosphors to be extended. In addition, by forming a barrier which demarcates the unit emission regions, interference of emitted light between the unit emission regions is inhibited, thereby eliminating erroneous discharge.

In forming the phosphors, a paste, in which a phosphor powder is mixed into a vehicle comprised of, for example, a resin, organic solvent or plasticizer, is typically coated on the surface of the back substrate in which the address electrodes and barrier are formed, followed by volatilizing the vehicle by heat treatment and baking.

A three-electrode surface discharge type of plasma display panel as described above is described in, for example, Patent Document 1:] Japanese Patent Application Laid-open No. 2005-183125. This patent document describes a PDP capable of inhibiting phosphor deterioration over time while maintaining a high level of emission efficiency, and a production process thereof.

### SUMMARY OF THE INVENTION

Although a three-electrode surface discharge type of panel of the prior art is resistant to ion bombardment during plasma discharge by providing the phosphors on a back substrate, since phosphors are still present in the discharge space, damage caused by ion bombardment accompanying address discharge occurring between the display electrodes the address electrodes, and sustain discharge occurring between display electrodes, cannot be completely avoided. Although the number of address discharges is low, the phosphors are still subjected to the ion bombardment, and although the sustain discharge is surface discharge between the display electrodes of the substrate, phosphors provided at the upper portion of the barrier side walls are subjected to ion bombardment. This ion bombardment invites deterioration of the phosphors and causes a reduction in panel lifetime.

Moreover, although the vehicle in the phosphor paste is removed by heat treatment, since it cannot always be completely removed, a trace amount of organic matter remains in the phosphors. Since this organic matter causes phosphor deterioration, brightness is attempted to be stabilized by carrying out an aging step consisting of continuous discharge after the front substrate and back substrate have been sealed to form a panel. However, this aging step leads to increased production costs.

Therefore, an object of the present invention is to provide a plasma display panel, and a production process thereof, capable of eliminating phosphor deterioration caused by ion bombardment and avoiding increases in costs attributable to an aging step.

According to a first aspect of the present invention to achieve the above-mentioned object, a plurality of display electrodes, a dielectric layer covering the display electrodes, and a protective layer protecting the dielectric layer, are formed on a front side first substrate, a plurality of address electrodes, forming unit emission regions at the locations of intersection with the display electrodes, are formed on a second substrate, a third substrate is adhered on the second substrate with phosphors interposed therebetween, and the first substrate and the second substrate are sealed with a barrier which demarcates the unit emission regions interposed therebetween.

According to this first aspect, since the phosphors are separated from a discharge space by the second substrate, the lifetime of the phosphors can be extended as a result of not being subjected to ion bombardment.

According to a second aspect of the present invention to achieve the above-mentioned object, a plasma display panel which carries out a prescribed display by causing a plasma discharge within a discharge space has a first transparent substrate, having, on a side of the discharge space, a plurality of display electrodes, a dielectric layer covering the display electrodes, and a protective layer which covers the dielectric layer, protects the dielectric layer from ion bombardment occurring during the plasma discharge and emits secondary ions; a second substrate provided in opposition to the first substrate with the discharge space interposed therebetween, having a plurality of address electrodes arranged on a side of the discharge space so as to intersect with the display electrodes; and a third substrate adhered on the opposite side of the second substrate from the discharge space with phosphors, which are provided at locations corresponding to unit emission regions where the display electrodes and address electrodes intersect, interposed therebetween; wherein the first substrate and the second substrate are sealed with a barrier which demarcates the unit emission regions interposed therebetween.

According to a preferable mode of this second aspect, a secondary ion emission layer is formed on the lateral surface of the barrier. As a result thereof, the effective discharge voltage can be lowered and emission efficiency can be improved. In addition, according to a different preferable mode, light emitted by the phosphors can be effectively guided to the front side by forming the phosphors on a reflective layer.

According to a third aspect of the present invention to achieve the above-mentioned object, a production process of a plasma display panel which carries out a prescribed display by causing a plasma discharge within a discharge space has the steps of: forming a first transparent substrate, having a plurality of display electrodes, a dielectric layer covering the display electrodes, and a protective layer covering the dielectric layer, on a side of the discharge space; forming a second substrate, having a plurality of address electrodes arranged so as to intersect with the display electrodes, on a side of the discharge space; forming recesses in a third substrate at locations corresponding to unit emission regions where the display electrodes and the address electrodes intersect, and filling phosphors into the recesses; laminating the second substrate onto the side of the third substrate in which the recesses are formed either before the address electrodes are formed or after the address electrodes have been formed; and sealing the first substrate and the second substrate with a barrier which demarcates the unit emission regions interposed between both substrates.

According to this third aspect, an aging step can be eliminated by filling phosphor powders into recesses formed in the third substrate or recesses formed in the second substrate.

According to the present invention, phosphor lifetime can be extended without causing deterioration thereof attributable to ion bombardment.

### BRIEF DESCRIPTION OF THE DRAWINGS

FIG. 1 is a cross-sectional view of three-electrode surface discharge type of plasma display panel of the prior art.

FIG. 2 is a cross-sectional view of a plasma display panel of a first embodiment.

FIG. 3 is an overhead view showing the production process of a second substrate.

FIG. 4 is an overhead view showing the production process of a second substrate.

FIG. 5 is an overhead view in which display electrodes are superimposed on the second substrate of FIG. 4.

FIG. 6 is an overhead view of a third substrate.

FIG. 7 is a different overhead view of a third substrate.

FIG. 8 is a cross-sectional view of a plasma display panel of a second embodiment.

FIG. 9 is an overhead view of a first substrate of a second embodiment.

FIG. 10 is a different overhead view of a first substrate of as second embodiment.

FIG. 11 is an overhead view showing display electrodes 11 and address electrodes ADD superimposed on a matrix-like barrier 16 of FIG. 10.

FIG. 12 is a cross-sectional view of a plasma display panel of a third embodiment.

### DETAILED DESCRIPTION OF THE PREFERRED EMBODIMENTS

The following provides an explanation of embodiments of the present invention with reference to the drawings. However, the technical scope of the present invention is not limited to these embodiments, but rather extends to the matters described in the scope of claim for patent and matters equivalent thereto.

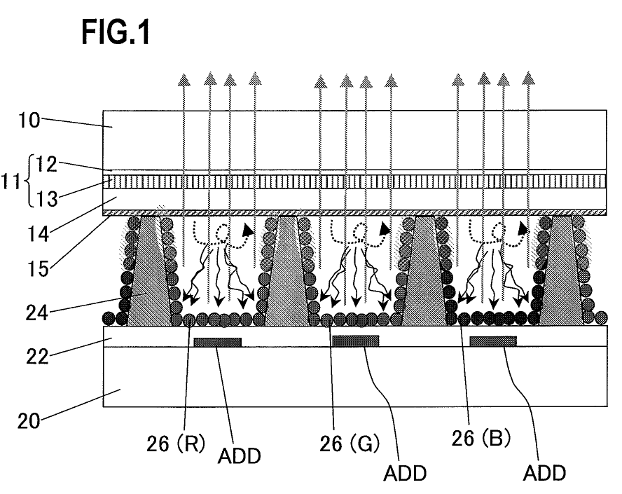

FIG. 1 is a cross-sectional view of a three-electrode surface discharge type of plasma display panel of the prior art. Display electrodes 11, comprised of a transparent electrode 12 and a bus electrode 13 of a highly conductive metal (three-layer structure of Cr/Cu/Cr) superimposed thereon, a dielectric layer 14 covering the display electrodes 11, and a protective layer 15 comprised of MgO covering the dielectric layer 14, are formed on a side of a discharge space of a front side glass substrate 10.

On the other hand, address electrodes ADD, which intersect with the display electrodes 11 and form unit emission regions at the locations of those intersections, a dielectric layer 22 covering the address electrodes ADD, and a barrier 24, in the form of stripes or in the form of a matrix comprised of vertical walls and horizontal walls, are formed on a side of the discharge space of a back side substrate 20. This barrier 24 demarcates the unit emission regions and prevents discharge interference between adjacent unit discharge regions.

Phosphors 26 in the three colors of red, green and blue (RGB) are provided on the dielectric layer 22 of the back side substrate 20 and on the side of the barrier 24. The phosphors 26 are formed by coating a paste in which a phosphor powder is mixed with a vehicle onto the surface of the back side substrate 20 on which the barrier 24 is formed, and baking after volatilizing the vehicle by high-temperature treatment to leave only the phosphor powder.

In the plasma display panel of FIG. 1, an address discharge is generated between the display electrodes 11 and the address electrodes ADD during an address period, and an electrical charge generated by the discharge accumulates on the surfaces of the dielectric layer 14 and the protective layer 15. During a sustain discharge period following the address period, a voltage is alternately applied between adjacent display electrodes, and a sustain discharge is repeated by using a wall electric charge accumulated during the address period. As indicated with the upward arrows, light emitted by the phosphors is output towards the front side substrate as a result of ultraviolet light generated during the discharge generation exciting the phosphors resulting in emission of light. A desired brightness can be displayed according to the number of these sustained discharges.

As shown in FIG. 1, since phosphors 26 are provided on the back side substrate, and the sustain discharge accounting for the majority of the plasma discharge is a surface discharge occurring between the display electrodes of the front side substrate, phosphors 26 are not directly subjected to ion bombardment during discharge. Even so, since the phosphors 26 are exposed in the discharge space, ion bombardment during plasma discharge cannot be completely avoided. In particular, phosphors 26 in the vicinity of the apex of the barrier 24 are susceptible to ion bombardment generated by sustain discharge between the display electrodes. Thus, this causes deterioration of the phosphors and shortening of the panel lifetime.

In addition, although the phosphor paste is coated by a printing method and so forth followed by high-temperature treatment, since the vehicle (such as a resin, organic solvent or plasticizer) in the paste cannot be completely removed, aging is carried out by applying a high voltage after the panel has been formed. This aging step leads to increased costs.

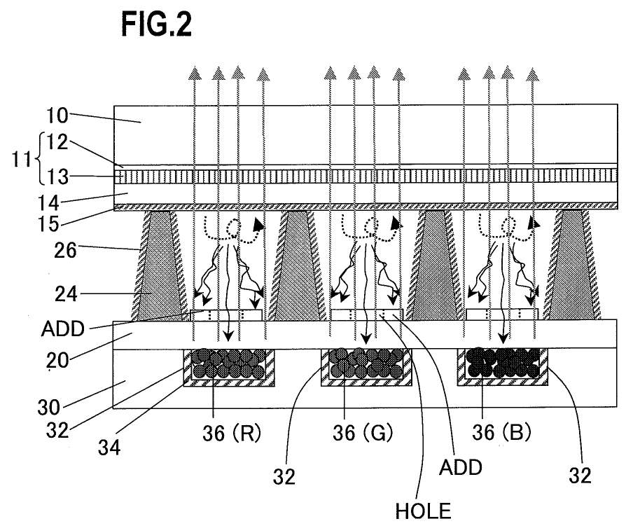

FIG. 2 is a cross-sectional view of a plasma display panel of a first embodiment. Although the constitution of the front side first substrate 10 is the same as in FIG. 1, a characteristic of this first embodiment is that the back side second substrate 20 in which the address electrodes ADD are formed separates the phosphors 36 from the discharge space surrounded by the barrier 24 and the upper and lower substrates 10 and 20. As a result, the phosphors 36 are not subjected to ion bombardment during plasma discharge, deterioration of the phosphors over time is inhibited, and the lifetime of the panel can be extended.

A third substrate 30 is provided adhered on the opposite side of the second substrate 20 from the discharge space. Recesses 32 are formed in the third substrate 30 at locations corresponding to the unit emission regions, and phosphor powders are filled into these recesses 32. However, these recesses 32 may also be provided on the back side of the second substrate 20, and in either case, the second substrate 20 and the third substrate 30 are adhered with the phosphors 36 interposed therebetween. Since phosphor powders can be filled into the recesses 32, it is not necessary to coat a phosphor base followed by high-temperature treatment as in the prior art, thereby making it possible to eliminate the need for the aging step responsible for increasing production costs.

In the example of a constitution of FIG. 2, the second substrate 20 is comprised of a transparent substrate which allows transmission of ultraviolet light generated by plasma discharge as well as transmission of light emitted by the phosphors in the form of visible light, and the barrier 24 is provided on the second substrate 20 for demarcating the unit emission regions. In addition, since the phosphors 36 are provided on the back side of the second substrate 20, a dielectric layer comprised of a glass material having a low melting point is not provided for covering the address electrodes ADD.

Moreover, a secondary electron emission layer 26 comprised of MgO is formed on the lateral surface of the barrier 24. The protective layer 15 on the side of the first substrate 10 is also an MgO layer, and these layers 15 and 26 emit secondary electrons in response to ion bombardment during plasma discharge. Thus, emission efficiency is improved by increasing the emission level of secondary electrons during discharge to either lower the effective discharge voltage or increase the amount of emitted light if the discharge voltage is the same. In other words, by providing the phosphors on the back side of the second substrate 20, the secondary electron emission layer 26 comprised of MgO can be formed on the barrier 24.

In addition, a reflective layer 34 such as Cr or Cu is formed on the inner surfaces of the recesses 32 of the third substrate into which phosphor powder is filled. Since a comparatively large number of phosphor powders 36 are filled into the recesses 32 and the light emitted by those phosphors is reflected by the reflective layer 34, emitted light can be efficiently guided to the front side, thereby making it possible to enhance emission efficiency.

The address electrodes ADD formed on the surface of the second substrate 20 are formed from a transparent electrode material so as to enable emitted light to be transmitted from the phosphors. For example, this transparent electrode material may be ITO, SnO₂ or Ga₂O₃. Ultraviolet light transmitting holes HOLE are formed in the centers of the address electrodes ADD to allow transmission of ultraviolet light. Ultraviolet light is guided to the phosphors 36 located directly below through these center holes HOLE, while derivation to the phosphors 36 of unit emission regions adjacent thereto in the diagonal direction is inhibited.

In the plasma display panel shown in FIG. 2, since the structure of the first substrate 10 is the same as that of the example of the prior art shown in FIG. 1, an explanation of the production process thereof is omitted. The production processes of the second substrate 20 and the third substrate 30 are explained with reference to overhead views.

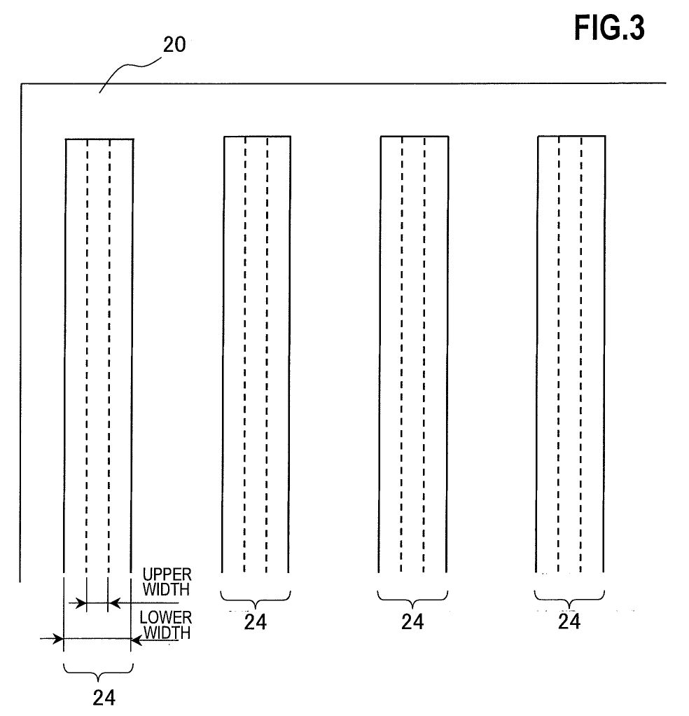

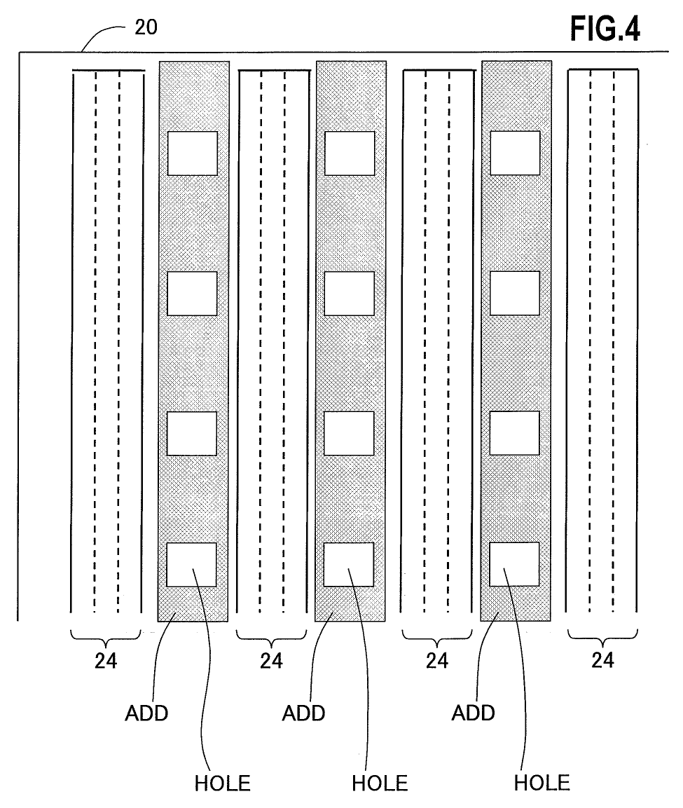

FIG. 3 and FIG. 4 are overhead views showing the production process of the second substrate 20. First, the barrier 24 in the form of a plurality of stripes is formed on the surface of the second substrate 20 comprised of a transparent resin substrate by direct etching of regions other than the barrier 24 by a method such as laser forming or chemical etching. Alternatively, the barrier 24 may also be formed by applying a thick coating of a glass paste having a low melting temperature to the second substrate 20 comprised of a transparent glass substrate or resin substrate, forming multiple stripe pattern by sand blasting using a mask film, and then baking at a high temperature. This state is shown in the overhead view of FIG. 3. The solid lines of the barrier 24 indicate the bottom surfaces, while the broken lines indicate the apical surfaces, and unit emission regions are formed in the regions interposed by the barrier 24.

Next, as shown in FIG. 4, the address electrodes ADD comprised of the above-mentioned transparent electrode material are formed between the barriers 24. These address electrodes are formed by either sputtering the transparent electrode material onto the entire surface of the substrate followed by forming into stripes using ordinary lithography technology, or by sputtering with a mask having striped passage pattern arranged on the upper surface of the substrate to form the address electrodes in a striped pattern. Square holes HOLE for allowing transmission of ultraviolet light are then formed at the locations corresponding to the unit emission regions of the address electrodes ADD.

Although not shown in the drawings, a secondary electron emission layer comprised of MgO is formed on the side walls and apices of the barrier. This layer is preferably formed in the same manner as the address electrodes either by sputtering MgO over the entire surface followed by allowing it to remain on the barrier by ordinary lithography technology, or by sputtering MgO with a mask having a striped passage pattern arranged on the upper surface of the substrate.

In the present embodiment, a dielectric layer which covers the address electrodes ADD is not formed. In the example of the prior art of FIG. 1, as a result of providing the dielectric layer 22, a glass paste layer for forming a barrier thereon can be patterned by sandblasting. In other words, the dielectric layer 22 has the function of protecting the address electrodes during sandblasting as well as the function of improving adhesion between the substrate and the barrier when the mask film of the sandblasting step is peeled off. In the present embodiment however, since it is necessary to radiate ultraviolet light onto the phosphors on the back of the second substrate 20, it is preferable to not provide such a dielectric layer to prevent attenuation of the ultraviolet light.

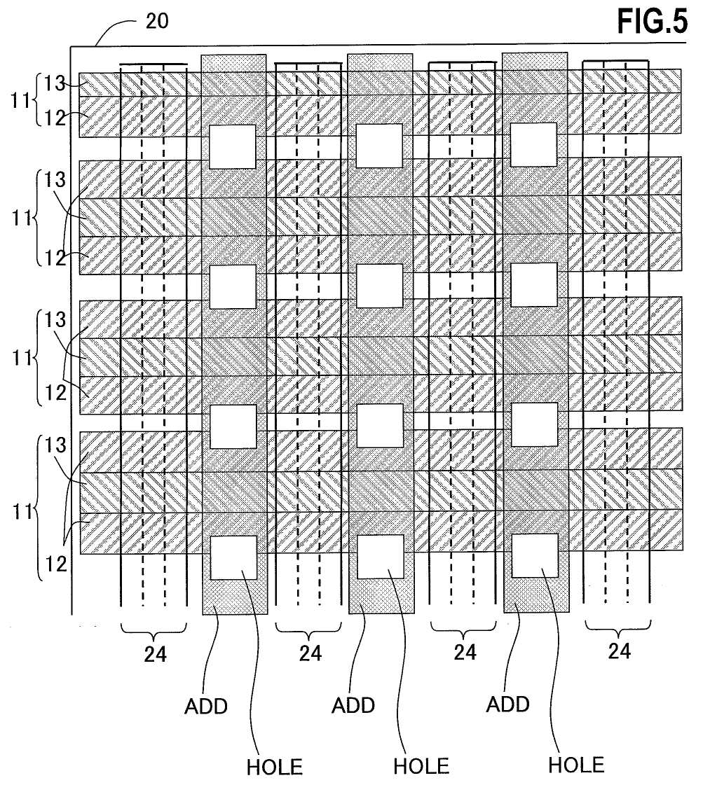

FIG. 5 is an overhead view in which display electrodes are superimposed on the second substrate of FIG. 4. This drawing shows the relationship between the unit emission regions at the locations where the display electrodes and the address electrode intersect, and the ultraviolet transmission holes HOLE of the address electrodes. The display electrodes 11 are composed transparent electrodes 12 and bus electrodes 13 formed overlapping the central portions thereof. The regions in opposition to the transparent electrodes 12 and interposed by the barrier 24 correspond to the unit emission regions. The ultraviolet transmission holes HOLE of the address electrodes ADD are formed at those locations overlapping these unit emission regions.

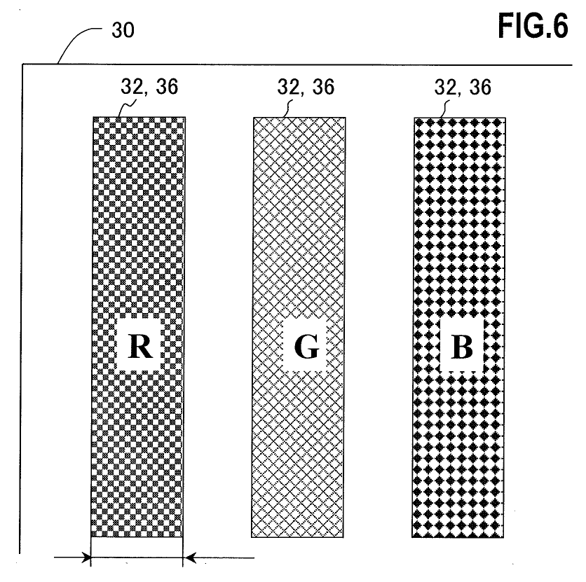

FIG. 6 is an overhead view of the third substrate. This third substrate 30 is a glass substrate or resin substrate, and the recesses 32 are formed in a striped pattern at the locations corresponding to the unit emission regions. This striped pattern conforms to the regions between the stripes of the barrier 24 as shown in FIG. 2 and FIG. 3. In addition, in the case the third substrate 30 is a resin substrate, it can be laminated with the second substrate 20 with an adhesive, and grooves for applying that adhesive are formed around the third substrate 30.

Grooves for applying a sealant are also formed by directly etching the substrate for the recesses 32 as well. This direct etching process is carried out by laser forming or chemical etching. The depth of the recesses 32 into which the phosphors are filled is, for example, preferably about 100 to 300 μm.

Reflective layers are then formed on the inner surfaces of the recesses 32. These reflective layers are formed by sputtering a reflective film over the entire surface of the third substrate 30 followed by patterning while leaving only the inner surfaces of the recesses 32 by ordinary lithography technology. Alternatively, a reflective layer material may be sputtered only on the insides of the recesses with a mask fixed on the third substrate 30. Subsequently, three colors (RGB) of phosphor powders are filled into the recesses 32 in which the reflective layer has been formed. A dispensing method or blade method is preferably used for filling. Here, a phosphor paste like that of the example of the prior art is not used.

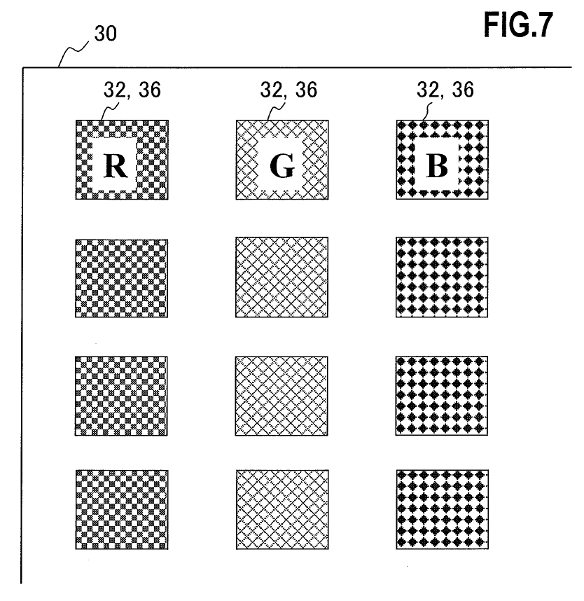

FIG. 7 is a different overhead view of the third substrate. In the example of FIG. 7, after having been formed by a direct etching process in the third substrate 30, the recesses 32 are patterned as a plurality of rectangles arranged in the form of a matrix instead of a striped pattern. These rectangular recesses 32 are formed at locations matching the unit emission regions where the display electrodes and the address electrodes of the first and second substrates intersect. Thus, these rectangular recesses 32 also match the ultraviolet transmission holes HOLE formed in the address electrodes ADD. Reflective layers are then formed on the inner surfaces of the recesses 32 and phosphor powders are filled therein.

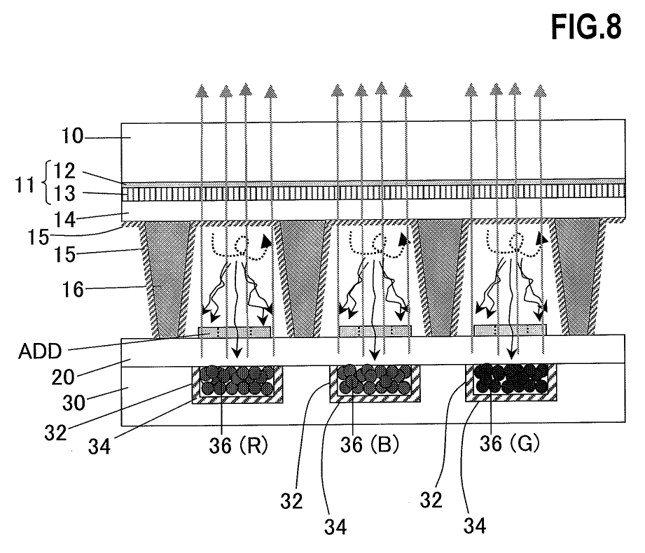

FIG. 8 is a cross-sectional view of a plasma display panel in a second embodiment. This plasma display panel differs from that of the first embodiment shown in FIG. 2 in that a barrier 16, which demarcates the unit emission regions, is formed on the first substrate 10, and a combination protective layer/secondary electron emission layer 15 comprised of MgO is formed on the surfaces of a dielectric layer 14 and the barrier 16. Other aspects of this second embodiment are the same as the first embodiment.

The display electrodes 11 comprised of the transparent electrodes 12 and the bus electrodes 13 are formed on the transparent first substrate 10, and the dielectric layer 14 is formed covering the display electrodes 11. The barrier 16, in the form of a striped pattern or a matrix pattern composed of horizontal walls and vertical walls, is formed on the dielectric layer 14, and an MgO layer 15 is formed on the dielectric layer 14 and the barrier 16.

Only the address electrodes ADD are formed on the transparent second substrate 20. The third substrate 30, in which phosphor powders have been filled into the recesses 32, is adhered to the back side of the second substrate 20. The reflective layer 34 is formed on the inner surfaces of the recesses 32 so as to guide light emitted from the phosphors to the front side.

Since the phosphors 36 are separated from the discharge space by the second substrate 20, in this second embodiment as well, the phosphors are not subjected to ion bombardment accompanying discharge, and the lifetime thereof can be extended. In addition, since the phosphor powders are filled into the recesses 32, it is not necessary to use a phosphor paste, and an aging step of stabilizing brightness is also not required.

In addition, emission efficiency is improved due to the combination protective layer/secondary electron emission layer 15 comprised of MgO, and emission efficiency is further improved by the reflective layer 34 on the inner surfaces of the recesses 32.

Since the phosphors are provided on the third substrate 30 in this second embodiment, a dielectric layer covering the address electrodes ADD is not required to be provided, and ultraviolet light is prevented from being attenuated during discharge. In addition, since the phosphors are provided in the third substrate 30, it is not necessary to provide the barrier 16 on the second substrate and provide phosphors on the side walls thereof. Therefore, in this second embodiment, the degree of freedom of the barrier pattern is improved by providing the barrier 16 on the first substrate.

In other words, in the case of forming the barrier on the second substrate 20, a glass paste is applied after forming the address electrodes ADD, and the glass paste is patterned by sandblasting followed by baking at a high temperature. In the case of sandblasting, it is necessary to cover the address electrodes ADD with a dielectric layer for the purpose of protecting the address electrodes and so forth. However, if this dielectric layer is provided, ultraviolet light is attenuated thereby resulting in the risk of said ultraviolet light being unable to adequately reach the phosphors of the third substrate. Therefore, the barrier is formed on the first substrate and the dielectric layer on the address electrodes is eliminated since it is no longer necessary to form the barrier on the second substrate accompanying formation of the phosphors in the third substrate.

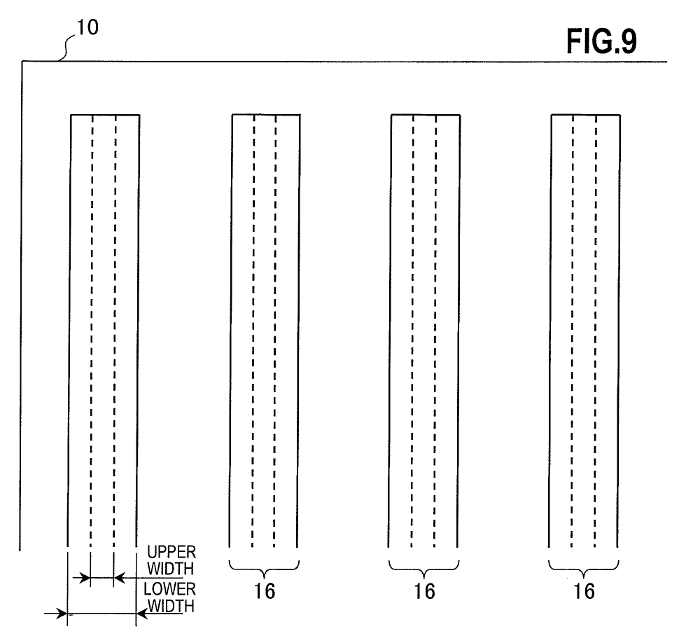

FIG. 9 is an overhead view of a first substrate in the second embodiment. Although the display electrodes 11 and the dielectric layer 14 are formed on the first substrate 10, these are not shown in FIG. 9. The barrier 16 is shown to have a striped pattern in FIG. 9. In the same manner as previously described, the solid lines indicate the lower sides of the barrier, while the broken lines indicate the apices. Unit emission regions are located between the stripes of the barrier 16.

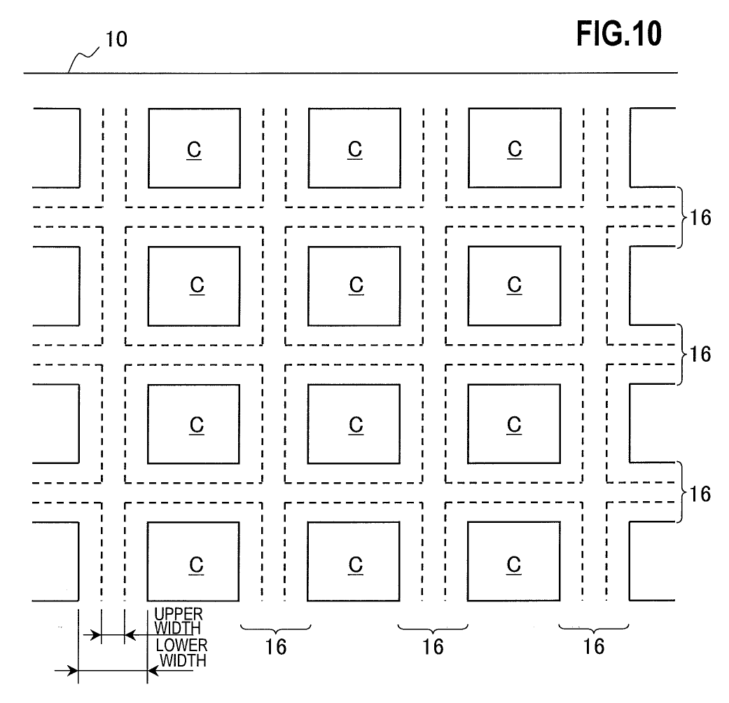

FIG. 10 is a different overhead view of a first substrate in the second embodiment. In this example, the barrier 16 has a matrix pattern comprised of walls in the vertical direction and walls in the horizontal direction, barrier 16 demarcates the unit emission regions C in four directions, and completely separates adjacent unit emission regions C.

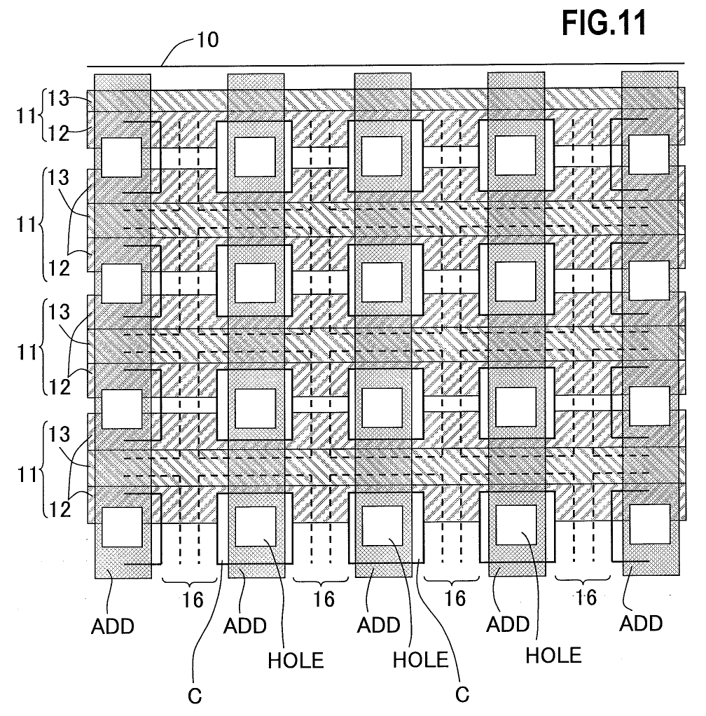

FIG. 11 is an overhead view showing the display electrodes 11 and the address electrodes ADD superimposed on the matrix-like barrier 16 of FIG. 10. The transparent electrodes 12 of two adjacent display electrodes 11 are arranged in opposition to unit emission regions C demarcated by the matrix-like barrier 16, and the bus electrodes 13 of the display electrodes 11 are arranged so as to overlap the barrier 16 extending in the horizontal direction. As a result, there is no opaque material to block the unit emission regions C demarcated by the barrier 16, and numerical aperture can be increased. In addition, the ultraviolet transmission holes HOLE of the address electrodes ADD are also arranged at locations corresponding to the unit emission regions C.

The overhead views of the third substrate in this second embodiment are the same as those of FIG. 6 and FIG. 7.

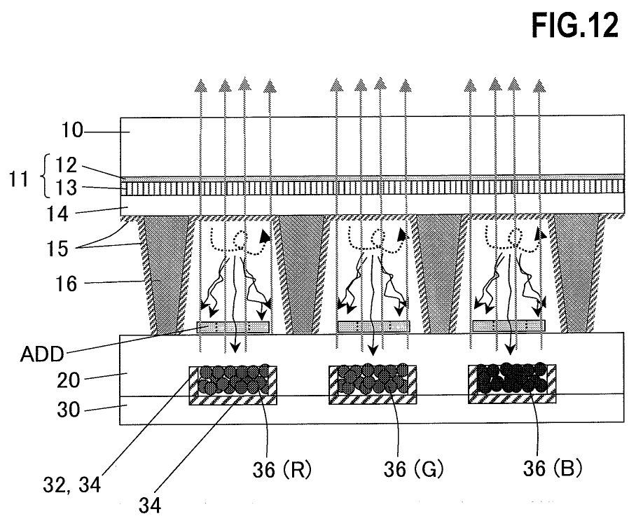

FIG. 12 is a cross-sectional view of a plasma display panel of a third embodiment. This third embodiment differs from the second embodiment in that the recesses 32 are formed on the opposite side of the second substrate 20 from the discharge space, the reflective layers 34 are formed on the lateral surfaces thereof, and phosphor powders 36 are filled into the recesses 32. Reflective layers 34 are formed on the third substrate 30 at locations corresponding to the phosphors 36. In addition, although the barrier 16 is formed on the first substrate 10 in the same manner as the second embodiment, it may also be formed on the second substrate. Other structures are the same as in the first and second embodiments.

As has been explained above, according to the present embodiment, since the phosphors are separated from the discharge space by the second substrate, the lifetime of the phosphors can be extended, and since the phosphors are filled into recesses in the third substrate or the second substrate, an aging step required when using phosphor paste is not required. In addition, since a reflective layer is provided around the phosphors and an MgO layer is provided on the barrier as well, effective emission efficiency is improved.

What is claimed:

1. An AC type color plasma display panel, comprising:
a first substrate,
a pair of display electrodes arranged in parallel on the first substrate,
a dielectric layer which covers the pair of display electrodes on the first substrate,
a protective layer which covers the dielectric layer on the first substrate,
a second substrate opposed to the first substrate,
an address electrode arranged on the second substrate, perpendicular to the pair of display electrodes,
a phosphor arranged on the second substrate,
wherein the phosphor is covered by a transparent layer which protects the phosphor from ion bombardment.

2. An AC type color plasma display panel according to claim 1,
wherein the address electrode is transparent and arranged on the transparent layer, and the phosphor is arranged under the transparent layer.

3. An AC type color plasma display panel according to claim 2,
wherein the phosphor is arranged in a cavity formed on the second substrate, and the transparent layer covers the cavity.

4. An AC type color plasma display panel according to claim 3,
wherein a reflective layer is arranged on the surface of the cavity on the second substrate.

5. An AC type color plasma display panel according to claim 1,
wherein a barrier rib is arranged on the transparent layer and a electron emitting layer is arranged on the surface of the barrier rib.

6. An AC type color plasma display panel according to claim 5,
wherein the protective layer and the electron emitting layer are MgO layers.

7. An AC type color plasma display panel according to claim 1,
wherein the transparent layer transmits ultraviolet ray and visible light.

8. An AC type color plasma display, comprising:
a first substrate,
a pair of display electrodes arranged in parallel on the first substrate,
a dielectric layer which covers the pair of display electrodes on the first substrate,
a protective layer which covers the dielectric layer on the first substrate,
a second substrate opposed to the first substrate,
an address electrode arranged on the second substrate, perpendicular to the pair of display electrodes,
wherein the address electrode is transparent and a phosphor is arranged under the transparent address electrode.

9. A plasma display panel which carries out a prescribed display by causing a plasma discharge within a discharge space; comprising:
a first transparent substrate, having, on a side of the discharge space, a plurality of display electrodes, a dielectric layer covering the display electrodes, and a protective layer which covers the dielectric layer, protects the dielectric layer from ion bombardment occurring during the plasma discharge and emits secondary ions;
a second substrate provided in opposition to the first substrate with the discharge space interposed therebetween, having a plurality of address electrodes arranged on a side of the discharge space so as to intersect with the display electrodes; and
a third substrate adhered on the opposite side of the second substrate from the discharge space with phosphors, which are provided at locations corresponding to unit emission regions where the display electrodes and address electrodes intersect, interposed therebetween; wherein
the first substrate and the second substrate are sealed with a barrier which demarcates the unit emission regions interposed therebetween.

10. The plasma display panel according to claim 9, wherein the third substrate is provided with recesses at locations corresponding to unit emission regions where the display electrodes and the address electrodes intersect, and the phosphors are filled into the recesses.

11. The plasma display panel according to claim 10, wherein the recesses in the third substrate are of a plurality of grooved structures in the form of a stripe along the unit emission regions, or a plurality of grooved structures formed in the form of a matrix corresponding to the unit emission regions.

12. The plasma display panel according to claim 10, wherein a reflective layer which reflects light emitted by the phosphors is formed in the recesses of the third substrate, and the phosphors are filled onto the reflective layer.

13. The plasma display panel according to claim 12, wherein the reflective layer is a layer having at least one of Cr and Cu.

14. The plasma display panel according to claim 9, wherein a secondary electron emission layer, which emits secondary electrons during the plasma discharge, is provided on the side surface of the barrier.

15. The plasma display panel according to claim 14, wherein the protective layer and the secondary electron emission layer are both MgO layers.

16. The plasma display panel according to claim 9, wherein the address electrodes are formed from a transparent electrode material, and holes for transmission of ultraviolet light are formed in the address electrodes at locations corresponding to the phosphors.

17. The plasma display panel according to claim 16, wherein the transparent electrode material of the address electrodes is ITO, SnO₂ or Ga₂O₃.

18. The plasma display panel according to claim 9, wherein the barrier is of a structure having a plurality of striped barriers extending in one direction with the unit emission regions interposed therebetween, or a structure having a plurality of vertical barriers extending in the vertical direction and a plurality of horizontal barriers extending in the horizontal direction with the unit emission regions interposed therebetween.

19. The plasma display panel according to claim 18, wherein the barrier is formed on the second substrate or the first substrate, and provided between the first substrate and second substrate as a result of the first substrate and the second substrate being sealed.

20. The plasma display panel according to claim 9, wherein the second substrate is a glass substrate or a resin substrate which transmits ultraviolet light and visible light.

21. A production process of a plasma display panel which carries out a prescribed display by causing a plasma discharge within a discharge space; comprising the steps of:
forming a first transparent substrate, having a plurality of display electrodes, a dielectric layer covering the display electrodes, and a protective layer covering the dielectric layer, on a side of the discharge space;
forming a second substrate, having a plurality of address electrodes arranged so as to intersect with the display electrodes, on a side of the discharge space;
forming recesses in a third substrate at locations corresponding to unit emission regions where the display electrodes and the address electrodes intersect, and filling phosphors into the recesses;
laminating the second substrate onto the side of the third substrate in which the recesses are formed either before the address electrodes are formed or after the address electrodes have been formed; and
sealing the first substrate and the second substrate with a barrier which demarcates the unit emission regions interposed between both substrates.

22. The production process of a plasma display panel according to claim 21, wherein the step of forming the recesses in the third substrate is carried out by a process in which the regions where the recesses are formed in the third substrate are etched directly.

23. The production process of a plasma display panel according to claim 22, further comprising a step of forming a reflective layer, which reflects light emitted by the phosphors, on the insides of the recesses of the third substrate.

24. The production process of a plasma display panel according to claim 21, further comprising a step of forming the barrier on the first substrate or the second substrate, and a step of forming a secondary electron emission layer, which emits secondary electrons during the plasma discharge, on the barrier.
